(19) United States
(12) Patent Application Publication
(10) Pub. No.: US 2026/0159333 A1
(43) Pub. Date: Jun. 11, 2026

(54) Distributing Conveyor for Distributing Packs

(71) Applicant: KHS Gmbh, Dortmund (DE)

(72) Inventors: Daniel Düpper, Kleve (DE); Thomas Nitsch, Kleve (DE); Simon Uphues, Kleve (DE)

(21) Appl. No.: 18/722,114

(22) PCT Filed: Jan. 5, 2023
(86) PCT No.: PCT/EP2023/050145

§ 371 Date: Jun. 20, 2024

(30) Foreign Application Priority Data
Jan. 17, 2022 (DE) 10 2022 100 904.1

(51) Int. Cl. B65G 47/28

(52) U.S. Cl. CPC B65G 47/28

(57) ABSTRACT

The invention relates to a distributing conveyor for distributing packs, in particular packs of containers, said distributing conveyor comprising a plurality of peripherally driven product carriers (1) which can be moved in a distributing section of the distributing conveyor along at least two guide tracks (3a, 3b, 3c, 3d) in the conveying direction (F), at least some of the product carriers (1) being guided by a guide pin (6) along one of the guide tracks (3a, 3b, 3c, 3d). According to the invention, at least some of the product carriers (1) have a deflection element (9, 10) which is separate from the guide pin (6) and is designed to divide the product carriers (1) between the guide tracks (3a, 3b, 3c, 3d) by engaging in one of at least two deflection devices (7, 8) positioned adjacent to one another.

### RELATED APPLICATIONS

This application is a national phase under 35 USC 371 of international application no. PCT/EP2023/050145, filed Jan. 5, 2023, which claims the benefit of the Jan. 17, 2022 priority date of German application no. DE 10 2022 100 904.1, the contents of all of which are incorporated herein by reference in their entireties.

### FIELD OF INVENTION

The invention relates to a distribution conveyor for distributing packs, in particular packs of containers.

### BACKGROUND

In the beverage industry, it is usual to fill containers and to then form them into packs. The packs are then guided to a distributing conveyor that distributes the packs onto several part streams for the purpose of downstream processing, such as the fitting of a carrying handle.

A distribution conveyor usually includes a deflector that is configured as an adjustable set of deflection switch points that interact with guide pins of product carriers. The product carriers are usually connected mechanically to one another. Only the frontmost product carriers comprise such a guide pin.

Rotation of the deflection switch points guides the guide pins alternately into one of the guide tracks. Since the deflection switch points require time to switch over the setting position, it is necessary for only one of the product carriers to be configured with a corresponding guide pin. The time between two guide pins engaging into the deflector can then be used to change the setting position of the deflection switch points.

Because there is only one guide pin per transport group, the forces imposed on this guide pin are significant. On the one hand, this can impair the performance of the distribution conveyor.

In addition to this, it has been shown that, due to the period of time required for setting the deflection switch points, the build-up of transport groups is not sufficiently flexible.

### SUMMARY

The object of the present invention is to provide a distributing conveyor which is characterized by greater flexibility and longer service life.

In one aspect, the invention features a distribution conveyor that comprising a plurality of peripherally driven product carrier, that can be moved in a distributing section of the distributing conveyor along at least two guide tracks in the conveying direction,. The product carriers are guided at least in part by a guide pin along one of the guide tracks, and wherein at least one deflection element is provided for dividing the product carriers onto the guide tracks.

In another aspect, at least two deflection devices are provided arranged adjacent to one another. In addition, the product carriers comprise a deflection element formed separately from the guide pin, which is configured such that, by engaging into one of the at least two deflection devices arranged adjacent to one another, they cause a distribution of the product carriers onto the guide tracks.

The individual product carriers therefore comprise not only a guide pin, but also a deflection element provided separately from the guide pin. The object of the deflection element in this situation is to distribute the product carriers inside the deflection devices onto the individual guide tracks, while the guiding of the product carriers themselves is taken over further by the guide pin. Accordingly, the deflection element actively engages into the guiding of the product carriers only in the region of the deflection devices, while the guide pin preferably lies freely in this region, and only resumes the guiding of the product carriers as soon as the product carrier engages into the assigned guide track. The at least one deflection element can also be configured as a deflection element.

The deflection element is preferably arranged perpendicular to the conveying direction, adjacent to the guide pin, wherein, for the allocation of the individual transport groups onto the guide tracks, different arrangements of the deflection elements are provided. Preferably, a first number of product carriers comprise a deflection element on a first side of the product carriers, and a second number comprise a deflection element on a second side of the product carriers, wherein deflection elements on the first side are provided such as to engage into the first deflection device, and deflection elements on the second side are provided such as to engage into the second deflection device.

It is therefore clear that, by means of configuration according to the invention, with a distribution onto a guide pin and a deflection element, a distribution of loading between the individual elements is possible, as a result of which, in particular, the stress on the material is reduced. At the same time, in the simplest form of the configuration according to the invention, a distribution onto two guide tracks is also possible, without an adjustment of the deflection devices being in some way necessary.

However, it also falls within the framework of the invention that the deflection devices are configured as adjustable switch points. As a result, it is possible for a distribution onto two guide tracks to be made, but also onto three, four, or more guide tracks. One advantageous configuration makes provision for four guide tracks, wherein three guide tracks are provided for the further transport, and a fourth guide track serves as an exclusion track, by means of which damaged or otherwise disadvantageous packs can be screened out. For the distribution onto the individual guide tracks, the deflection devices, configured as deflection points, can then be adjusted, in particular rotated. Preferably, several setting positions are provided, wherein individual setting positions are spaced apart from one another, for example at angles of rotation of between 4° and 12°, and preferably between 6° and 10°. In a configuration in which one of the guide tracks is provided as an exclusion guide track, this guide track can be spaced apart, in relation to the conveying direction, for example by an angle of rotation of 12° to 20°, and preferably between 14° and 18°. With such a configuration, the particular advantage is also achieved that the guidance in the region of the deflection devices is taken over only by one of the two deflection devices, such that there is accordingly sufficient time available for the respective other deflection device to set the corresponding setting position or for the selection of the required guide track. As a result, it is possible for the number of guide tracks required to be increased. As well as this, the advantage is also achieved that the individual product carriers no longer necessarily need to be mechanically coupled to one another.

One preferred embodiment makes provision that each product carrier comprises a guide pin, such that a build-up of transport groups is derived solely by the setting or the arrangement of the deflection element. This has the advantage that, additionally, the individual product carriers can now be configured in each case with one guide pin, such that the force taking effect as a result of the deflection and guiding, is divided onto a plurality of deflection elements and guide pins. Accordingly, the individual elements can be configured as thinner in respect of their material thickness and exhibit a longer service life. In this situation, account is also taken of the fact that, in the region of a deflection or rise, the individual product carriers of a group can be pushed an amount further towards one another. It has been shown, however, that such a displacement transverse to the transport direction is not disadvantageous for the packs being transported on it.

According to one preferred embodiment, the at least one deflection element is configured as adjustable. Even if in this case the invention is not restricted to specific embodiment forms, one particularly advantageous embodiment makes provision that the product carriers in each case comprise two deflection elements spaced apart from one another, wherein the deflection elements are adjustable in relation to one another in such a way that only one of the deflection elements can be brought into engagement with one of the deflection devices. Such a configuration can make provision, for example, that the guide pin is arranged between the deflection elements, wherein the two deflection elements are arranged at the product carrier in such a way that a first deflection element is provided for engagement with the first deflection device, and a second deflection element is provided for engagement with the second deflection device. The deflection elements are then arranged in each case in an adjustable manner and can optionally either be brought into engagement with the assigned deflection device or not. This usually takes place by an adjustment movement in the direction of the product carrier surface, wherein the product carrier surface describes the side of the product carriers which are provided for receiving the packs which are to be transported. Accordingly, the deflection elements can be drawn out of engagement in the deflection devices by movement in the direction of the product carrier surface, wherein accordingly, by an adjustment of the deflection elements in relation to the product surface, an engagement into the corresponding deflection devices is possible.

In addition to this, according to such an embodiment provision is also made for only one of the two deflection elements to be arranged in an engagement position, and the respective other deflection element is not arranged in an engagement position. For this purpose, the two deflection elements can be mechanically coupled, for example in the form of a lever arrangement. Particularly preferred, however, is a configuration with a longitudinally displaceable plate with two mutually opposed curve guides. The deflection elements engage in each case into the curve guide by means of an adjustment pin. Due to the opposed movement of the curve guides, a simultaneous opposed movement of the deflection elements is also incurred. Regardless of the specific configuration, a movement of the first deflection element into an engagement position leads to a movement of the second deflection element out of the engagement position. It is of course also possible, however, within the framework of the invention, that with the use of two separate deflection elements no corresponding mechanical coupling is provided. According to such a configuration, however, it must then also always be ensured, for example by way of a visual inspection, that only one of the deflection elements per product carrier is in an engagement position.

A further embodiment of the invention further makes provision for the guide pins to project in relation to the deflection elements in a direction perpendicular to the conveying direction or in a direction perpendicular to the product carrier surface. Accordingly, the guide pins are usually configured as longer than the deflection elements. Such a configuration has the advantage that, during the movement of the product carriers along the individual guide tracks, the likewise projecting deflection elements cannot be brought into engagement with other mechanical components. This is problematic in particular if the individual guide tracks increasingly run apart from one another, wherein accordingly the individual deflection elements, with an identically long configuration in relation to the guide pins, could be brought into engagement with these guide tracks, such that any further movement of the product carriers would be prevented.

Preferably, the ratio arising from the projecting length of the guide pins in relation to the projecting length of the deflection elements in a setting position amounts to between 1.5:1 and 2.5:1, and for particular preference to between 1.8:1 and 2.2:1. The projecting length relates in this situation to the length of the guide pins and the deflection elements related to a product carrier underside facing away from the product carrier surface.

According to a preferred embodiment, the deflection devices configured as deflection switch points can be adjusted by means of a motor of the distributing conveyor. In this situation, this is preferably a servomotor. Servomotors are special electric motors which allow for the monitoring and control of the angular position of their motor shaft as well as of the speed of rotation and acceleration. They consist essentially of an electric motor, which is additionally equipped with a sensor for the determination of position. As a result of this, it is possible for a precisely positioned adjustment of the deflection devices to be achieved, such that a plurality of guide tracks can be actuated.

A further embodiment of the invention makes provision that a collection guide track is arranged on a return section of the distributing conveyor located opposite the distribution section. This collection guide track is configured such as to gather together the product carriers divided in the distribution section onto the individual guide tracks, such that, by means of a corresponding deflection in an inlet section, they can once again be conveyed to the individual deflection devices. The collection guide track can essentially consist of guide track elements arranged in a V-shape.

One preferred further embodiment of the invention makes provision that a grouping device is provided for the adjustment of the deflection elements. As has already been explained heretofore, the individual product carriers can be grouped with one another by the adjustment setting of the deflection elements. Inasmuch as, for example, it is intended that a plurality of product carriers arranged behind one another should be grouped together, then they must also exhibit an identical setting of the deflection elements. This necessarily then leads to a situation in which the product carriers also run through the same guide track, and therefore form on their product carrier surfaces a common transport surface for receiving a pack.

By the adjustment of the individual defection elements with the aid of the grouping device, the deflection elements can be adjusted in such a way that larger or smaller transport groups can be formed from them. One preferred embodiment makes provision in this situation for the product carriers to be assembled to form transport groups, wherein each transport group is configured such as to run through the same guide track. Preferably between four and ten product carriers are assembled to form a transport group. For particular preference, the product carriers can be assembled to form transport groups of six or eight product carriers each.

According to one preferred embodiment, the grouping device comprises at least one plunger which can be actuated vertically in order to press at least one of the deflection elements. One plunger is in principle sufficient if the two deflection elements of a product carrier are coupled to one another mechanically. However, if two plungers are provided, the two deflection elements can be engaged independently of one another.

The grouping device is preferably arranged between the return section and the deflection devices. This has the advantage that the individual product carriers can be gathered together first, such that one individual stationary grouping device is sufficient to adjust the individual deflection elements.

The device is explained in greater detail hereinafter on the basis of an exemplary embodiment. The Figures show:

### BRIEF DESCRIPTION OF THE FIGURES

FIG. 1 shows a view from above a distribution conveyor;

FIG. 2 show an isometric view of the distribution conveyor of FIG. 1;

FIGS. 3A and 3B show different views of the product carriers used in the distribution conveyor of FIG. 1; and

FIG. 4 shows the return section of the distribution conveyor of FIG. 1.

### DETAILED DESCRIPTION

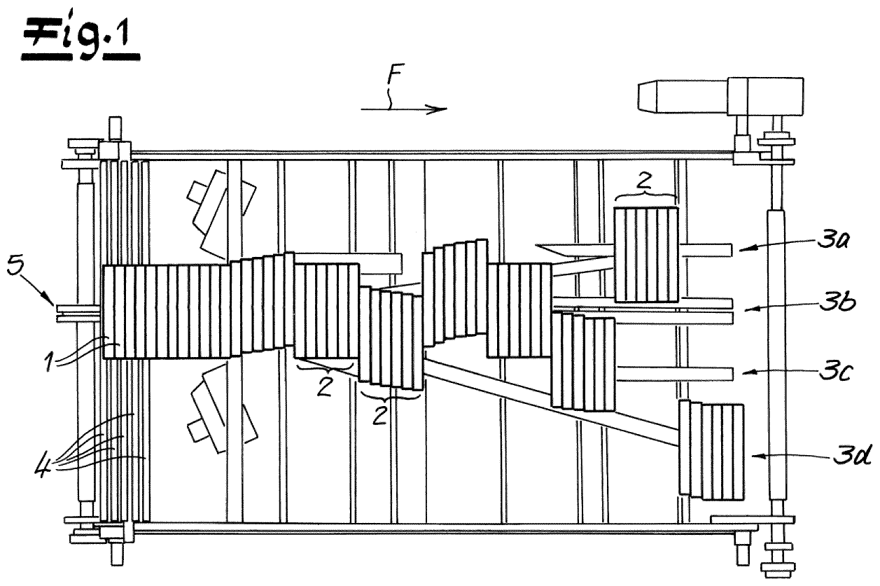

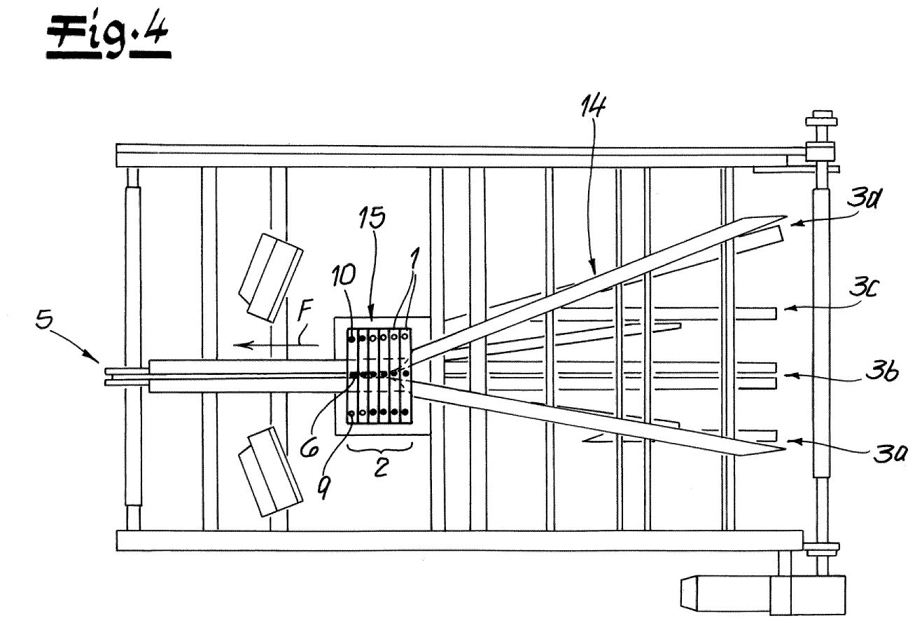

FIG. 1 shows a view from above a distribution conveyor. The distribution conveyor has a distribution section that distributes individual product carriers 1, which are adjacent to each other. The distribution conveyor assembles these product carriers 1 to form transport groups 2. In the illustrated embodiment, each transport group 2 has six product carriers 1. As the transport groups 2 move in a conveying direction F, the distribution conveyor distributes them onto distribution tracks 3a, 3b, 3c, 3d. Upon completion of this task, the distributed conveyor recirculates the product carriers 1 so that they can be used again. Details of this recirculation will be discussed in connection with FIG. 4.

The product carriers move as a result of being engaged to plate bars 4 that extend transverse to the conveying direction F. A chain drive propels each plate bar 4 along the conveying direction F. To avoid excessive clutter, FIG. 1 shows only five of these plate bars 4.

In the illustrated embodiment, each plate bar 4 engages a pair of adjacent product carriers 1. As a result of the chain drive moving the plate bar 4, the pair of product carrier 1 moves along the conveying direction with the plate bar 4. The product carriers 1 are arranged at the plate bars 4 so as to be movable along the plate bars 4 in a direction perpendicular to the conveying direction F.

As is apparent from FIG. 1, product carriers 1 are first delivered together and flush with each other at some intermediate position along the width of the conveyor, such as centrally along the conveyor's width. The individual product carriers 1 are then displaced along the plate bar 4 in a direction transverse to the conveying direction F. This results in formation of individual transport groups 2.

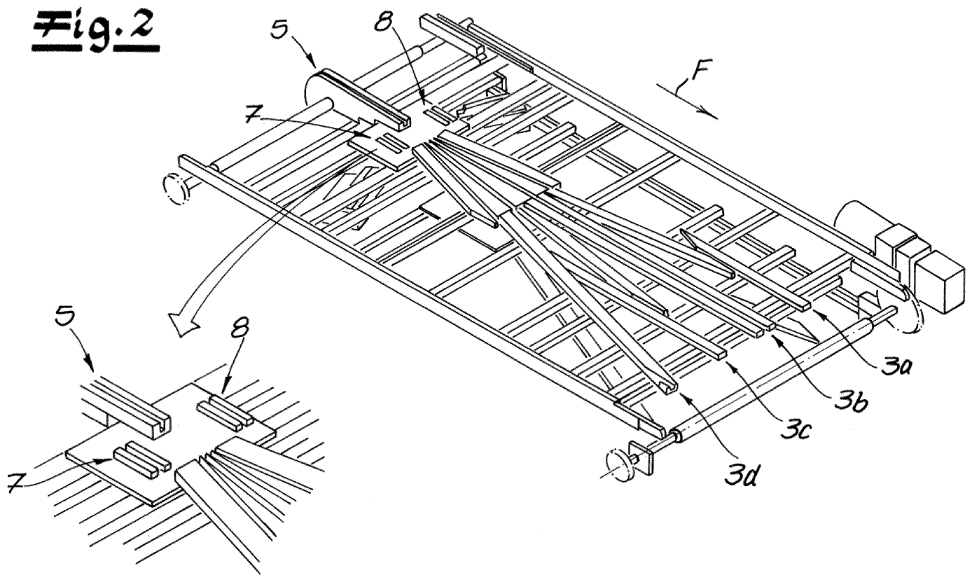

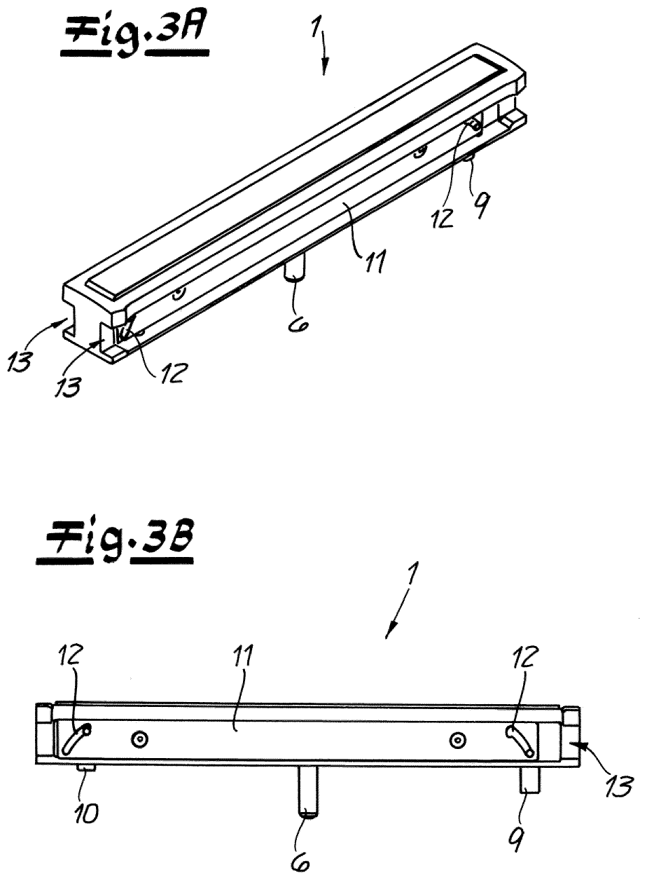

Referring now to FIG. 2, formation of individual transport groups 2 relies on a curved inlet track 5 at the beginning of the distribution section. A groove in the inlet track 5 engages a guide pin 6 that protrudes from each product carrier 1, as shown in FIGS. 3A and 3B.

Referring back to FIG. 2, first and second deflectors 7, 8 lie downstream of the inlet track 5. These function as adjustable deflection switch points. The deflectors 7, 8 interact by engaging with deflection pins 9, 10 on the product carriers 1, as shown in FIGS. 3A and 3B. The deflection pins 9, 10 are separate from the guide pins 6. These deflection pins 9, 10 enable the deflectors 7, 8 to deflect the product carrier 1 onto a selected one of the distribution tracks 3a, 3b, 3c, 3d shown in FIG. 2.

As the product carrier 1 moves through the deflectors 7, 8, only one its deflection pins 9, 10 engages a deflector 7, 8. While the product carrier 1 traverses a deflector 7, 8, its guide pin 6 is free. They do not engage any of the distribution tracks 3a, 3b, 3c, 3d.

In FIG. 2, the deflectors 7, 8 are parallel to each other. However, they are in fact rotatable. A servomotor, which is omitted from the figure for the sake of clarity, rotates the deflectors 7, 8 about a vertical axis of rotation. As a result, the deflectors 7, 8 steer product carriers 1 onto the individual distribution tracks 3a, 3b, 3c, 3d.

In the illustrated embodiment, each product carrier 1 comprises a guide pin 6 and first and second deflection pins 9, 10, all of which protrude downward from the product carrier 1. The first deflection pin 9 and the second deflection pin 10 protrude by individually adjustable extents, as suggested by FIG. 3B.

In the particular embodiment shown in FIG. 3B, the first deflection pin 9 is in its engagement position whereas the second deflection pin 10 is in its retracted position. As a result, the first deflection pin 9 engages the second deflector 8 while the second deflection pin 10 passes over the first deflector 7 without engaging it.

Referring now to FIGS. 3A and 3B, an adjustment plate 11 with curve guides 12 mechanically couples the deflection pins 9, 10 to one another. As a result of this coupling, only one of the two deflection pins 9, 10 can be brought into an engagement position. Bringing the first deflection pin 9 into engagement position automatically retracts the second deflection pin 10 and vice versa.

FIG. 3B shows that the guide pin 6 projects further than either deflection pin 9, 10. This allows the deflection pins 9, 10 to pass freely over the distribution tracks 3a, 3b, 3c, 3d.

FIG. 3A further shows a double-T that forms the profile the product carrier 1 as viewed along its longitudinal axis. This creates two lateral grooves 13, each of which extends along the length of the product carrier 1. These grooves 13 engage adjacent plate bars 4.

In the embodiment shown in FIG. 2, the distribution conveyor has first, second, third, and fourth distribution tracks 3a, 3b, 3c, 3d. Excluded products, such as damaged or visually imperfect packs, are screened out via the fourth distribution track 3d. The individual distribution tracks 3a, 3b, 3c, 3d are offset to one another at an angle of eight degrees. As a result, the servomotors are configured to rotate the deflectors 7, 8 in discrete steps corresponding to this angular offset.

FIG. 4 shows a return section on the distribution conveyor's underside. The return section includes a pair of return tracks 14 arranged in a “V”. These return tracks 14 guide product carriers 1 back to a common track so that they can be delivered once again to the deflectors 7, 8 via the inlet track 5.

A grouper 15 located immediately behind the guide track elements 14 uses vertically actuated plungers to move the deflection pins 9, 10 into either the engagement position or the retracted position. FIG. 4 codes the position by using a filled circle and a hollow circle to show deflection pins 9, 10 in an engaged and retracted position, respectively.

In FIG. 4, the leftmost product carriers 1 have their second deflection pins 10 brought into an engagement position and their first deflection pins 9 in a retracted position whereas the remaining product carriers 1 have the opposite configuration of pins 9, 10. The grouper 15 essentially groups individual product carriers 1 into transport groups 1 on the basis of the positions their respective deflection pins 9, 10. As a result, a total of six, eight, or more product carriers 1 can be assembled to form a transport group 2. The individual transport groups 1 accordingly differ from one another as a result of the position setting of the deflection pins 9, 10. For example, in FIG. 4, the leftmost two product carriers 1 will belong to one transport group 2 and the remaining product carriers 1 will belong to another transport group 2.

An advantage of the foregoing configuration is that all the product carriers 1 can be configured with a guide pin 6 as well as first and second deflection pins 9, 10. A coupling of the individual product carriers to one another is no longer necessary, as a result of which the force taking effect on the guide pins 6 can be distributed onto a plurality of product carriers 1. At the same time, individual transport groups 2 always travel through the deflectors 7, 8 alternatingly, as a result of which a sufficient space of time is provided for adjusting the deflectors 7, 8.

Having described the invention and a preferred embodiment thereof, what is claimed as new and secured by letters patent is:

1-15. (canceled)

16. An apparatus comprising a distribution conveyor for distributing packs of containers, said distribution conveyor comprising a distribution section that includes distribution tracks, peripherally-driven product carriers that move along the distribution tracks in a conveying direction, and first and second deflectors for deflecting said product carriers onto selected ones of said distribution tracks, said first and second deflectors being adjacent to each other, wherein each of said product carriers comprises a guide pin to guide said product carrier along one of said distribution tracks and deflection pins, one of which engages one of said deflectors.

17. The apparatus of claim 15, wherein at least one of said deflection pins is adjustable.

18. The apparatus of claim 15, wherein said deflection pins are configured to be adjusted in relation to each other such that when said first deflection pin engages said first deflector, said second deflection pin fails to engage said second deflector.

19. The apparatus of claim 15, wherein said first and second deflection pins has an engagement position in which said deflection pin engages one of said deflectors, and wherein, when said first deflection pin is in said engagement position, said first deflection pin protrudes further from said product carrier than said second deflection pin.

20. The apparatus of claim 15, wherein said guide pin projects further from said product carrier than said first and second deflection pins.

21. The apparatus of claim 15, wherein said distribution section comprises at least three of said distribution tracks.

22. The apparatus of claim 15, wherein said deflectors are adjustable.

23. The apparatus of claim 15, wherein said deflectors are rotatable by a servomotor.

24. The apparatus of claim 15, wherein said product carriers are assembled to form transport groups and wherein each transport group travels long a single one of said distribution tracks.

25. The apparatus of claim 15, wherein said product carriers comprise first and second product carriers that belong to a transport group and wherein deflection pins in said first product carrier and deflection pins in said second product carrier are configured identically.

26. The apparatus of claim 15, wherein said distribution conveyor comprises a return section of said distributing conveyor that is on a side opposite said distribution section and wherein said return section comprises return tracks for collecting pairs of product carriers that have traversed said distribution tracks.

27. The apparatus of claim 15, wherein said distribution conveyor further comprises a grouping device on a return section of said distribution conveyor and wherein said grouping device adjusts said deflection pins of said product carriers.

28. The apparatus of claim 15, wherein said distribution conveyor further comprises a return section and a grouping device on said return section, wherein said grouping device is configured to vertically actuate a plunger that presses on of said deflection elements.
